(19) United States
(12) Patent Application Publication
(10) Pub. No.: US 2007/0044111 A1
(43) Pub. Date: Feb. 22, 2007

(54) Optical disc drive with magnetic disc locking device

(75) Inventors: Jeung Rak Lee, Suwon-Si (KR); Yong Hoon Lee, Suwon-Si (KR); Jae Yong Eum, Suwon-Si (KR); Hong Kyun Yim, Suwon-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/384,321

(22) Filed: Mar. 21, 2006

(30) Foreign Application Priority Data
Aug. 19, 2005 (KR) 10-2005-0076507

(51) Int. Cl. G11B 17/04

(52) U.S. Cl. 720/610

(57) ABSTRACT

A disc may be inserted or ejected from a turntable of an optical disc drive without applying excessive force to the disc, and the disc is securely locked onto the turntable when the disc is being rotated. The optical disc drive includes a turntable having a protruding boss for insertion into a mounting hole formed on a disc. First locks are disposed at the outer circumference of the boss, such that the first locks can move in the radial direction of the boss to lock the disc located on the turntable. Elastic members provide an elastic force to the first locks. A magnetic member is disposed above the boss, and a second lock disposed in the boss increases a locking force of the first locks only when the second lock interacts with the magnetic member.

### CROSS-REFERENCE TO RELATED APPLICATION

This application claims the benefit under 35 U.S.C. § 119(a) of Korean Patent Application No. 2005-76507, filed on Aug. 19, 2005 in the Korean Intellectual Property Office, the entire disclosure of which is hereby incorporated by reference.

### BACKGROUND OF THE INVENTION

1. Field of the Invention

The present invention relates to an optical disc drive. More particularly, the present invention relates to a disc locking device to lock an optical disc located on a turntable.

2. Description of the Related Art

An optical disc drive is an apparatus that irradiates light onto an optical disc, such as a compact disc (CD), a digital versatile disc (DVD), or a blue-ray disc (BD), to record information onto the optical disc or read information from the optical disc. Generally, the optical disc drive includes a turntable, on which an optical disc is located, a spindle motor mounted below the turntable to rotate the turntable, and a disc locking device to prevent the optical disc from separating from the turntable while the optical disc is rotated by the spindle motor.

FIG. 1 is a plan view illustrating a disc locking device integrally attached to a turntable of a conventional optical disc drive, and FIGS. 2A to 2C are sectional views taken along line I-I of FIG. 1 illustrating the operation of the conventional disc locking device. As shown in FIGS. 1 to 2C, the conventional optical disc drive includes a turntable 2, on which a disc 1 is located. The turntable 2 rotates around a rotary shaft 4 of a spindle motor (not shown), and a boss 3 having a predetermined height is formed on the turntable. The boss 3 is inserted into a mounting hole 1a of a disc 1. The disc locking device is disposed at the boss 3 to lock the disc 1 onto the turntable 2.

The disc locking device comprises disc locks 5 disposed at the outer circumference of the boss 3 to move in the radial direction of the boss 3 and springs 6 to provide an elastic force to press the disc locks 5 outward.

The operation of the disc locking device will be described with reference to FIGS. 2A to 2C. While the disc 1 is not located on the turntable 2, the disc locks 5 protrude outwardly from the outer circumference of the boss 3 due to the elastic force of the springs 6 (see FIG. 2A). When a user pushes the disc 1 onto the turntable 2, the disc locks 5 are pressed in by the disc 1 (see FIG. 2B). When the disc 1 is completely located on the turntable 2, the disc locks 5 moved outward due to the elastic force of the springs 6 to lock the disc 1 onto the turntable 2 (see FIG. 2C).

If the elastic force of the springs 6 is small, however, the disc 1 is not securely locked by the disc locks. As a result, when the disc 1 is rotated, the disc may be easily separated from the turntable 2 due to forces such as internal rotational vibration forces or external impact forces.

If the elastic force of the springs 6 is large, and the locking force of the disc locks 5 is increased, on the other hand, an excessive force is applied to the disc 1 when the user inserts or removes the disc 1. As a result, the disc 1 may be deformed, or cracks may occur around the mounting hole 1a of the disc 1, and therefore, the disc 1 may be broken. it is especially important when the disc locking device is applied to mobile equipment, such as a lap-top computer or a disc camcorder, for the disc 1 to be securely locked as a precaution against unexpected impacts. Consequently, the above-described problem is more severe in these applications.

Accordingly, there is a need for an improved disc locking device which securely locks a disk onto a turntable without subjecting the disc to excessive forces.

### SUMMARY OF THE INVENTION

An aspect of the present invention is to address at least the above problems and/or disadvantages and to provide at least the advantages described below. Accordingly, an aspect of the present invention is to provide an optical disc drive that is capable of enabling a disc to be inserted into or ejected from the optical disc drive, without applying an excessive force to the disc, to prevent the disc from being deformed or broken, and that is capable of enabling the disc to be securely locked onto a turntable, when the disc is recorded/reproduced, to prevent the disc from separating from the turntable due to impact.

In accordance with an aspect of the present invention, an optical disc drive comprises a turntable having a protruding for insertion into a mounting hole formed at the center of a disc, first locks disposed at the outer circumference of the boss, such that the first locks can move in the radial direction of the boss to lock the disc located on the turntable, elastic members disposed in the boss to provide an elastic force necessary for the first locks to lock the disc located on the turntable, a magnetic member disposed a distance away from the boss, and a second lock disposed in the boss to increase a locking force of the first locks when the second lock interacts with the magnetic member by a magnetic force.

The elastic members are preferably constructed such that the elastic members only have an elastic force sufficient to prevent the disc from being separated from the turntable due to the weight of the disc when the disc is fitted onto or ejected from the boss.

Consequently, the first locks do not apply a large amount of force to the disc when the disc is inserted or ejected, and therefore, the disc is prevented from being deformed or broken. Furthermore, the locking force of the first locks is increased by the second lock, when the disc is rotated after the disc is located on the turntable, and therefore, the disc is prevented from separating from the turntable.

The optical disc drive may further comprise a cover to open and close the top of the turntable, and the magnetic member may be attached to the lower surface of the cover at a position corresponding to the boss.

Each of the first locks may include an elastic member mounting part tangential to one side of the corresponding elastic member to receive the elastic force of the elastic member, a disc locking part that protrudes from the upper end of the elastic member mounting part to the outside of the boss to apply pressure to the disc located on the turntable, and a second lock contact part that protrudes from the upper end of the elastic member mounting part to the inside of the boss to receive a force applied from the second lock.

The second lock may be disposed between the second lock contact parts of the first locks and the elastic members such that the second lock can be vertically moved. The second lock may transmit a force generated by the interaction between the second lock and the magnetic member to the first locks to increase the locking force of the first locks, by which the disc located on the turntable is locked.

The disc locking part may have an upper inclined surface and a lower inclined surface which cooperate with the mounting hole of the disc to move smoothly toward the inside of the boss when the disc is fitted onto or ejected from the boss.

Each of the first locks may further include a guide part to guide the movement of the corresponding first lock and to prevent the corresponding first lock from separating from the boss.

At least one of the magnetic member and the second lock may be a magnet.

In accordance with another aspect of the present invention, an optical disc drive comprises a turntable having a protruding boss for insertion into a mounting hole formed at the center of a disc, disc locks disposed at the outer circumference of the boss, such that the disc locks can move in the radial direction of the boss to lock a disc onto the turntable, elastic members disposed in the boss to provide an elastic force necessary for the disc locks to lock the disc located on the turntable, and a magnetic member disposed distance a distance away from the boss. The disc locks are constructed such that the disc locks interact with the magnetic member by a magnetic force to increase the locking force of the disc locks when the magnetic force is applied between the disc locks and the magnetic member.

Each of the disc locks may includes an elastic member mounting part tangential to one side of the corresponding elastic member to receive the elastic force of the elastic member, a disc locking part that protrudes from the upper end of the elastic member mounting part to the outside of the boss to apply pressure to the disc located on the turntable, and a magnetic force applying part that protrudes from the upper end of the elastic member mounting part to the inside of the boss to interact with the magnetic member by a magnetic force.

The magnetic member may be disposed above the boss at positions corresponding to the magnetic force applying parts. The magnetic force applying part may be made of a magnet or a magnetic body.

In accordance with another aspect of the invention, an optical disc drive comprises a turntable having a protruding boss for insertion into a mounting hole formed at the center of a disc, disc locks disposed at the outer circumference of the boss, the disc locks moving in a radial direction of the boss to lock a disc onto the turntable, elastic members disposed in the boss, the elastic members engaging the disc locks to provide an elastic force to lock a disc onto the turntable, and magnetic means for increasing a locking force of the disc locks.

The magnetic means may comprise a magnetic member disposed above the boss, and a second lock engaging the disc locks. The second lock interacts with the magnetic member by a magnetic force to increase the locking force of the disc locks.

The magnetic member may be a magnet.

The magnetic means may also comprise a magnetic member disposed above the boss and magnetic force applying parts disposed on the disc locks. The magnetic force applying parts interact with the magnetic member by a magnetic force to increase the locking force of the disc locks.

Additional aspects and/or advantages of the invention will be set forth in part in the description which follows and, in part, will be obvious from the description, or may be learned by practice of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a plan view of a disc locking device integrally attached to a turntable of a conventional optical disc drive;

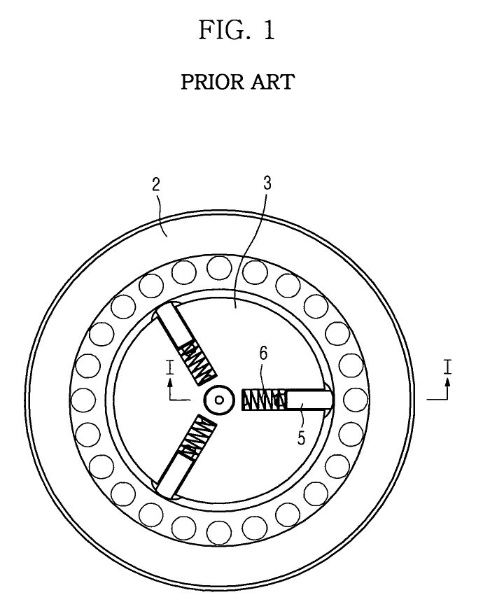

FIGS. 2A to 2C are sectional views taken along line I-I of FIG. 1 illustrating the operation of the conventional disc locking device of FIG. 1;

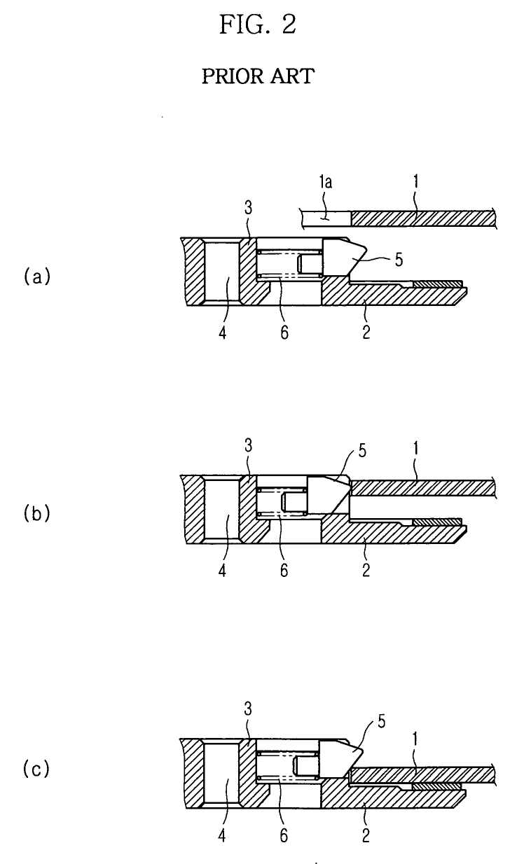

FIG. 3 is a perspective view illustrating the structure of an optical disc drive according to an exemplary embodiment of the present invention;

FIG. 4 is an enlarged view illustrating a disc locking device according to a first exemplary embodiment of the present invention, which is mounted in the optical disc drive;

FIG. 5 is a sectional view illustrating a turntable and a cover in FIG. 3, when the cover is closed;

FIG. 6 is a plan view of the turntable of the optical disc drive of FIG. 3, according to an exemplary embodiment of the present invention;

FIGS. 7A to 7D are sectional views illustrating the operation of the disc locking device in the optical disc drive according to the exemplary embodiment of the present invention illustrated in FIGS. 3-6; and

FIG. 8 is a sectional view illustrating a disc locking device according to a second exemplary embodiment of the present invention, which is mounted in the optical disc drive.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

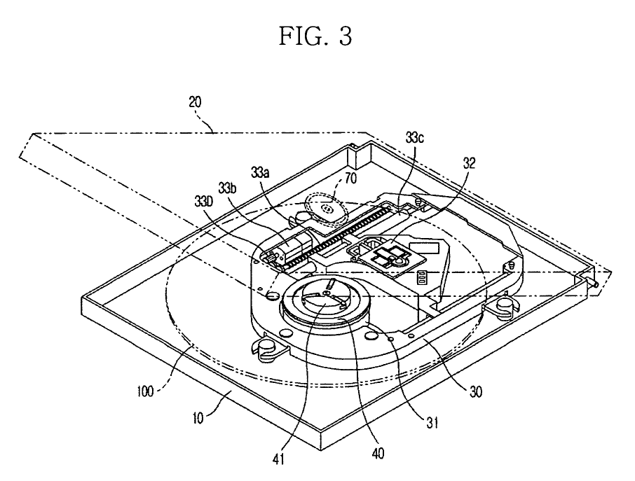

FIG. 3 is a perspective view illustrating the structure of an optical disc drive according to an exemplary embodiment of the present invention. As shown in FIG. 3, the optical disc drive includes a drive body 10 which is open at an upper part, a cover 20 that covers the open upper part of the drive body 10, and a main frame 30 disposed in the drive body 10 such that various components can be mounted at the main frame 30. In this exemplary embodiment, the cover 20 is hinged to one side of the drive body 10 so that the drive body 10 is opened and closed when a disc 100 is inserted or ejected. Also, the cover 20 serves as a door.

A turntable 40, on which the disc 100 is located to record/reproduce data, a spindle motor 31, which is disposed below the turntable 40 to rotate the turntable 40, and an optical pickup unit 32, which irradiates light to the disc 100 located on the turntable 40 to record data to the disc 100 or reproduce data stored in the disc 100, are disposed on the main frame 30.

A boss 41 is formed on the turntable 40, and protrudes to a predetermined height such that the boss 41 can be inserted into a mounting hole 110 formed at the center of the disc 100. A locking device (which will be described below in detail) to lock the disc 100 onto the turntable 40 is disposed on the boss 41.

The optical pickup unit 32 moves in the radial direction of the disc 100 to irradiate light to a recording surface of the disc 100. To this end, an optical pickup transferring unit 33, which includes a screw 33a, a drive motor 33b, a guide shaft 33c, and a gear 33d, is mounted at the main frame 30.

The optical disc drive further includes a disc locking device to prevent the disc 100 located on the turntable 40 from being separated from the turntable 40. According to the exemplary embodiments of the present invention, the disc locking device is constructed such that excessive force is not applied to the disc when a disc is inserted or ejected and the locking force to lock the disc is increased when data is recorded or reproduced.

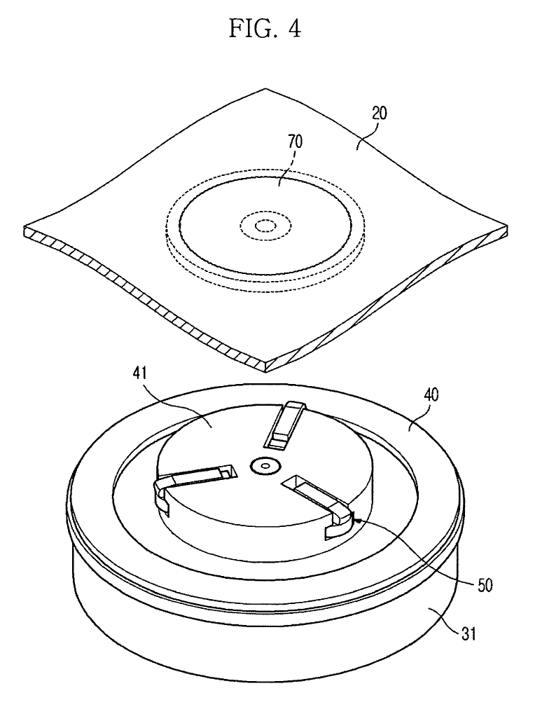

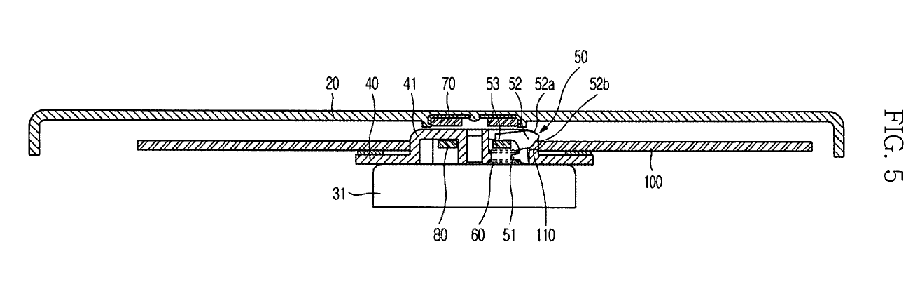

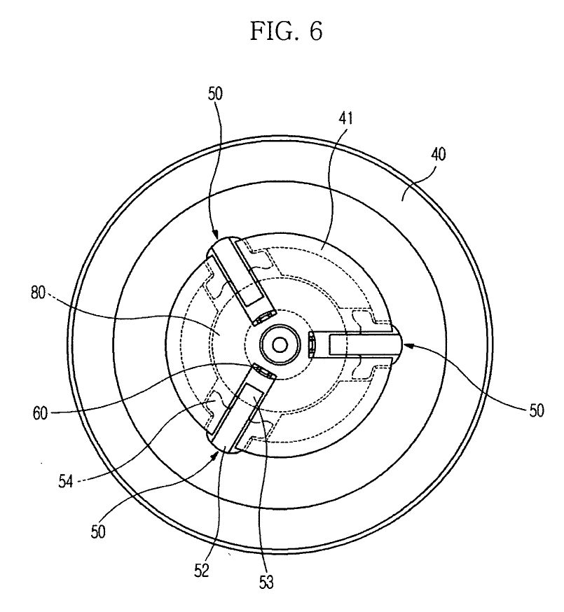

FIG. 4 is an enlarged view illustrating a disc locking device according to a first exemplary embodiment of the present invention, FIG. 5 is a sectional view illustrating the turntable and the cover of FIG. 3, when the cover is closed, and FIG. 6 is a plan view of the turntable of the optical disc drive of FIG. 3.

As shown in FIGS. 4 to 6, the disc locking device includes first locks 50 to lock the disc 100 onto the turntable 40, elastic members 60 to provide an elastic force for the first locks 50 to lock the disc 100, a magnetic member 70 disposed above the boss 41 while being spaced a distance away from the boss 41, and a second lock 80 disposed in the boss 41 to increase the locking force of the first locks 50 when the second lock 80 interacts with the magnetic member 70 by a magnetic force.

The first locks 50 are disposed at the outer circumference of the boss 41 such that the first locks 50 can move in the radial direction of the boss 41. The rear ends of the first locks 50 are elastically supported by the elastic members 60, respectively. When the disc 100 is located onto the turntable 40, the first locks 50 are moved toward the inside of the boss 41 such that the disc 100 can be inserted. When the insertion of the disc 100 is completed, the first locks 50 are moved toward the outside of the boss 41 by the elastic force of the elastic members 60. As a result, the first locks 50 apply pressure to the inner circumference of the mounting hole 110 to lock the disc 100. Preferably, two or more first locks 50 are arranged along the outer circumference of the boss 41 at equal intervals such that the first locks 50 can stably lock the disc 100 while an equilibrium of forces is achieved. Three first locks are shown in the exemplary embodiment of FIGS. 4 to 6.

Each of the first locks 50 includes an elastic member mounting part 51 tangential to one side of the corresponding elastic member 60 to receive the elastic force of the elastic member 60, a disc locking part 52 protruding from the upper end of the elastic member mounting part 51 to the outside of the boss 41 to apply pressure to the disc located on the turntable 40, and a second lock contact part 53 protruding towards the rear of the disc locking part 52 to receive a force from the second lock 80.

The disc locking part 52 has an upper inclined surface 52a, which is inclined downward toward the outside of the boss 41, and a lower inclined surface 52b, which is inclined downward toward the inside of the boss 41. The upper and lower inclined surfaces 52a and 52b facilitate smooth movement of the first locks 50 toward the inside of the boss 41 when a disc is fitted onto or ejected from the boss 41.

Each of the first locks 50 further includes a guide part 54 to guide the corresponding first lock 50 in the radial direction and to prevent the corresponding first lock 50 from separating from the boss 41.

The elastic members 60 are constructed such that the first locks 50 can be moved by even a small force when the disc 100 is inserted or ejected. For instance, in an exemplary embodiment, the elastic members 60 are constructed such that the elastic members 60 have an elastic force which is only sufficient to prevent the disc from separating from the turntable 40 due to the weight of the disc when the disc is fitted onto or ejected from the boss 41. Consequently, excessive force is not applied to the inner circumference of the mounting hole 110 of the disc 100 when the disc is inserted or ejected, and therefore, the disc locking device prevents the disc from being deformed or broken.

The second lock 80 is disposed between the second lock contact parts 53 and the elastic members 60 in the boss 41 such that the second lock 80 can be vertically moved. The second lock 80 may be ring shaped, and is composed of a magnet or a magnetic body, which interacts with the magnetic member 70 by a magnetic force. When no external force is applied to the second lock 80, that is, when the second lock 80 does not interact with the magnetic member 70, the second lock 80 is supported by the elastic members 60 disposed below the second lock 80. On the other hand, when the second lock 80 interacts with the magnetic member 70 by the magnetic force, the second lock 80 transmits an upward force to the first locks 50 to increase the locking force of the first locks 50, by which the disc located on the turntable is locked.

The magnetic member 70 is attached to the lower surface of the cover 20 at a position corresponding to the boss 41. In this exemplary embodiment, the cover 20 serves as a door, and therefore, when the cover 20 is closed, the magnetic member 70 is positioned above the boss 41. Consequently, when the cover 20 is closed after the disc is located onto the turntable 40, an attractive magnetic force is applied between the magnetic member 70 and the second lock 80, and the disc is securely locked. When the cover 20 is closed to insert or eject the disc, the distance between the magnetic member 70 and the second lock 80 is increased, and, therefore, the attractive force between the magnetic member 70 and the second lock 80 disappears. Consequently, the disc can be easily inserted and ejected by only a small force.

While the cover 20 is closed, however, the attractive force is applied between the magnetic member 70 and the second lock 80. As a result, it may be inconvenient to open the cover 20. To eliminate this inconvenience, the magnetic member 70 may be made of an electromagnet, and a button (not shown) to open the cover 20 may be utilized. When the button is pushed, the magnetic member 70 loses its magnetic force, and therefore, the cover 20 is easily opened.

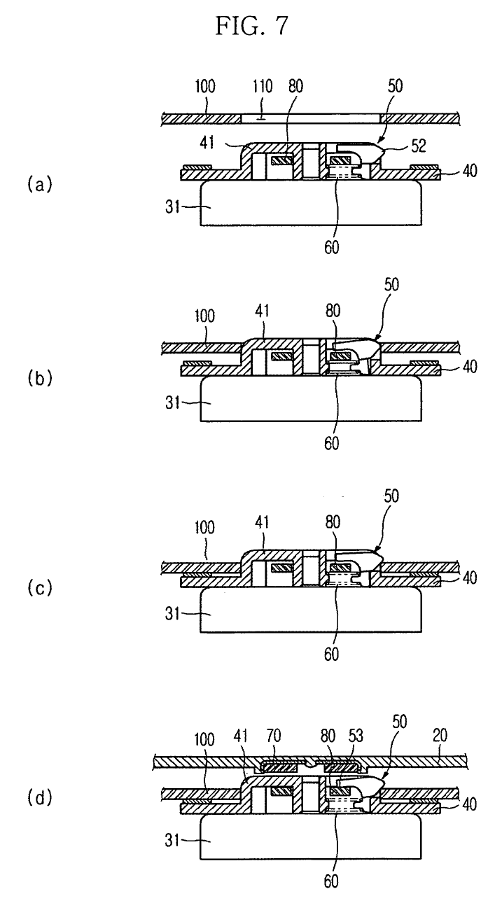

The operation of the disc locking device in the optical disc drive with the above-described construction will be described with reference to FIGS. 7A to 7D. When a disc is not located on the turntable 40, as shown in FIG. 7A, the disk locking parts 52 of the first locks 52 protrude outwardly from the outer circumference of the boss 41 by the elastic force of the elastic members 60. When a disc is fitted onto the boss 41 through the mounting hole 110, as shown in FIG. 7B, the inner circumference of the mounting hole 110 pushes the first locks 50 toward the inside of the boss 41. At this time, since the first locks 50 are elastically supported at the lower parts thereof, the first locks 50 are moved in such a manner that the upper parts of the first locks 50 are turned about the lower parts of the first locks 50. When the insertion of the disc is completed, as shown in FIG. 7C, the first locks 50 apply pressure to the inner circumference of the disc 100 by the elastic force of the elastic members 60 to lock the disc. When the cover 20 is closed, and the magnetic member 70 is positioned above the boss 41, as shown in FIG. 7D, the second lock 80 interacts with the magnetic member 70 by the magnetic force. As a result, the second lock 80 is moved upward to apply a force to the second lock contact parts 53 of the first locks 50. Consequently, the locking force of the first locks 50, by which the disc is locked, is increased, and therefore, the disc 100 is prevented from separating from the turntable 40 even when the disc 100 is rotated at high speed or when an external impact is applied to the disc 100.

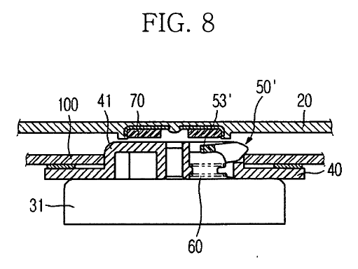

FIG. 8 is a sectional view illustrating a disc locking device according to a second exemplary embodiment of the present invention. The disc locking device according to this embodiment is substantially the same as the disc locking device according to the first exemplary embodiment, except that the disc locking device according to the second exemplary embodiment does not includes a second lock, and the magnetic member 70 interacts with disc locks 50′ by a magnetic force to increase the locking force of the disc locks 50′.

The disc locks 50′ correspond to the first locks 50 of the first exemplary embodiment. The shape and operation of the disc locks 50′ are substantially the same as those of the first locks 50. Unlike the first locks 50, however, each of the disc locks 50′ includes a magnetic force applying part 53′ configured to interact with the magnetic member 70. The magnetic force applying part 53′ is made of a magnet or a magnetic body.

The magnetic member 70 is mounted at the cover 20 at a position corresponding to the boss 41. Preferably, the magnetic member 70 is disposed above the magnetic force applying parts 53′.

As is apparent from the above description, the disc locking device according to the exemplary embodiments of the present invention is capable of enabling the disc to be inserted into the optical disc drive or ejected from the optical disc drive without applying excessive forces to the disc, thereby preventing the disc from being deformed or broken around the mounting hole of the disc.

Furthermore, the disc locking device is capable of enabling the disc to be securely locked onto the turntable, when the disc is rotated so that information may be recorded on or reproduced from the disc, to prevent the disc from separating from the turntable due to internal vibrations or external impacts.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An optical disc drive comprising:
a turntable having a protruding boss for insertion into a mounting hole formed at the center of a disc;
first locks disposed at the outer circumference of the boss, the first locks moving in a radial direction of the boss to lock a disc onto the turntable;
elastic members disposed in the boss, the elastic members engaging the first locks to provide an elastic force to lock a disc onto the turntable;
a magnetic member disposed above the boss, the magnetic member being spaced a distance away from the boss; and
a second lock disposed in the boss, the second lock interacting with the magnetic member to increase a locking force of the first locks.

2. The drive according to claim 1, wherein
the elastic members only have an elastic force sufficient to prevent the disc from being separated from the turntable due to the weight of the disc when the disc is fitted onto or ejected from the boss.

3. The drive according to claim 1, further comprising:
a cover to open and close the top of the turntable, the magnetic member being attached to the lower surface of the cover at a position corresponding to the boss.

4. The drive according to claim 1, wherein each of the first locks comprises:
an elastic member mounting part contacting one side of a corresponding elastic member to receive the elastic force of the elastic member;
a disc locking part protruding from an upper end of the elastic member mounting part to the outside of the boss to apply pressure to a disc located on the turntable; and
a second lock contact part protruding from the upper end of the elastic member mounting part to the inside of the boss to receive a force applied by the second lock.

5. The drive according to claim 4, wherein
the second lock is disposed between the second lock contact parts of the first locks and the elastic members such that the second lock can be vertically moved.

6. The drive according to claim 5, wherein
the second lock transmits a force generated by the interaction between the second lock and the magnetic member to the first locks to increase the locking force of the first locks.

7. The drive according to claim 4, wherein
the disc locking part comprises an upper inclined surface and a lower inclined surface, the upper and lower inclined surfaces cooperating with the mounting hole of a disk so that the corresponding first lock is moved toward the inside of the boss when the disc is fitted onto or ejected from the boss, respectively.

8. The drive according to claim 4, wherein each of the first locks further comprises:
a guide part to guide the movement of the corresponding first lock and to prevent the corresponding first lock from separating from the boss.

9. The drive according to claim 1, wherein
at least one of the magnetic member and the second lock is a magnet.

10. An optical disc drive comprising:
a turntable having a protruding boss for insertion into a mounting hole formed at the center of a disc;
disc locks disposed at the outer circumference of the boss, the disc locks moving in a radial direction of the boss to lock a disc onto the turntable;
elastic members disposed in the boss, the elastic members engaging the disc locks to provide an elastic force to lock a disc onto the turntable; and
a magnetic member disposed above the boss, the magnetic member being spaced a distance away from the boss;
wherein the disc locks interact with the magnetic member by a magnetic force, and the locking force of the disc locks is increased when a magnetic force is applied between the disc locks and the magnetic member.

11. The drive according to claim 10, wherein
the elastic members only have an elastic force sufficient to prevent the disc from being separated from the turntable due to the weight of the disc when the disc is fitted onto or ejected from the boss.

12. The drive according to claim 10, wherein each of the disc locks comprises:
an elastic member mounting part contacting one side of a corresponding elastic member to receive the elastic force of the elastic member;
a disc locking part protruding from an upper end of the elastic member mounting part to the outside of the boss to apply pressure to a disc located on the turntable; and
a magnetic force applying part protruding from the upper end of the elastic member mounting part to the inside of the boss to interact with the magnetic member by a magnetic force.

13. The drive according to claim 12, wherein
the magnetic member is disposed above the boss at positions corresponding to the magnetic force applying parts.

14. The drive according to claim 12, wherein
the magnetic force applying part is made of a magnet or a magnetic body.

15. The drive according to claim 12, wherein
the disc locking part comprises an upper inclined surface and a lower inclined surface, the upper and lower inclined surfaces cooperating with the mounting hole of a disk so that the corresponding first lock is moved toward the inside of the boss when the disc is fitted onto or ejected from the boss, respectively.

16. The drive according to claim 12, wherein each of the disc locks further includes
a guide part to guide the movement of the corresponding disc lock and to prevent the corresponding disc lock from separating from the boss.

17. An optical disc drive comprising:
a turntable having a protruding boss for insertion into a mounting hole formed at the center of a disc;
disc locks disposed at the outer circumference of the boss, the disc locks moving in a radial direction of the boss to lock a disc onto the turntable;
elastic members disposed in the boss, the elastic members engaging the disc locks to provide an elastic force to lock a disc onto the turntable; and
magnetic means for increasing a locking force of the disc locks.

18. The drive according to claim 17, wherein the magnetic means comprises:
a magnetic member disposed above the boss; and
a second lock engaging the disc locks, the second lock interacting with the magnetic member by a magnetic force to increase the locking force of the disc locks.

19. The drive according to claim 18, wherein
the magnetic member is a magnet.

20. The drive according to claim 17, wherein the magnetic means comprises:
a magnetic member disposed above the boss; and
magnetic force applying parts disposed on the disc locks, the magnetic force applying parts interacting with the magnetic member by a magnetic force to increase the locking force of the disc locks.
